(19) United States
(12) Patent Application Publication
(10) Pub. No.: US 2009/0280700 A1
(43) Pub. Date: Nov. 12, 2009

(54) ELECTRICAL CONNECTOR

(76) Inventors: Taizo SOGO, Tokyo (JP); Takayuki Arai, Tokyo (JP); Takeshi Sato, Tokyo (JP); Taku Kawano, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/436,934

(22) Filed: May 7, 2009

(30) Foreign Application Priority Data
May 8, 2008 (JP) 2008-122130

(51) Int. Cl. H01R 4/10

(52) U.S. Cl. 439/877

(57) ABSTRACT

An electrical connector is offered which has a crimp contact connected with a connector cable, the crimp contact being held in position to a connector housing without rattling. The crimp contact has sidewall surfaces of U-shaped cross section. The sidewall surfaces are located on opposite sides. The sidewall surfaces have outwardly facing engagement protrusions. The connector housing has a connector body and a disengagement-preventing cover for closing a top portion of the connector body to prevent the crimp contact from coming off upward after the crimp contact has been mounted in the connector body. The connector body has engagement portions in which the protrusions of the crimp contact are inserted and received perpendicularly to the longitudinal direction of the connector cable. The protrusions are engaged in the engagement portions. The disengagement-preventing cover is mounted to the connector body via a hinge such that the cover can be opened and closed.

### BACKGROUND OF THE INVENTION

1. Field of the Invention

The present invention relates to an electrical connector including a crimp contact and a connector housing in which the crimp contact is inserted and held.

2. Prior Art

In the prior art, in order that a connector cable be crimped and connected to a crimp contact and that the crimp contact be inserted into a connector housing, a cable 22 is mounted to the crimp contact 21, crimped and electrically connected to the crimp contact in a crimping portion 23, and fixed, for example, as shown in FIG. 3. Then, the crimp contact 21 is inserted from an opening at one end of the connector housing 24 made of a synthetic resin.

Thereafter, the crimp contact is made to pass over a protrusion 25 and is engaged. The protrusion 25 is formed on a resilient molded lance 24a of the connector housing 24. The protrusion 25 is located in an intermediate position of the longitudinal extent of the crimp contact 21 and projects in a direction perpendicular to the longitudinal direction of the crimp contact. The crimp contact 21 is locked against backward motion. In this way, the molded lance is formed in the direction of insertion of the crimp contact 21, thus forming a means for preventing the crimp contact from disengaging.

Another known structure is shown in FIG. 4, where a crimp contact 26 has a flexible contact lance 26a. If the crimp contact 26 is inserted into a connector housing 27 from the opening at one end of the housing 27 after a cable 22 has been connected and held to the crimp contact 26, the front end of the contact lance 26a falls when it passes over a step portion 27a and becomes caught on the step portion 27a which is formed in an intermediate position of the longitudinal extent of the housing 27 inside the housing 27. In this way, the crimp contact is prevented from moving in the direction opposite to the direction of insertion and thus does not disengage. Such conventional electrical connectors have structures as shown in FIGS. 5A and 5B, where the connectors are known to have contact lances 28a and 29a, respectively. Furthermore, a connector described in JPA-2006221819 is known.

In such conventional electrical connectors, however, a spear-like or wedge-like protrusion, known as a lance, is formed in the direction of insertion of the crimp contact 21 or crimp contact 26 and, therefore, disconnection is prevented. A slight gap is left between the front-end surface of the lance and the end surface of the engagement portion. This produces rattling in the direction of insertion. If the crimp contact is used repeatedly, the engagement between the lance and the engagement portion becomes less tight gradually. There arises a problem that if the crimp contact is strongly pulled in the direction reverse to the direction of insertion, the crimp contact comes off.

### SUMMARY OF THE INVENTION

The present invention is intended to solve the foregoing problems with the prior art. It is an object of the invention to provide an electrical connector having a crimp contact which is prevented from being pulled out longitudinally of a connector cable and which, when mounted in a connector housing, is prevented from rattling longitudinally of the crimp contact.

Accordingly, the present invention provides an electrical connector including a crimp contact electrically connected with a connector cable and a connector housing for placing the crimp contact in position and holding the crimp contact. The crimp contact has sidewall surfaces of U-shaped cross section on opposite sides. The sidewall surfaces have engagement protrusions extending outwardly. The connector housing has a connector body and a disengagement-preventing cover. The protrusions of the crimp contact are inserted into the connector body perpendicularly to the longitudinal direction of the connector cable and accommodated in the connector body. The connector body has engagement portions in which the protrusions are engaged. The disengagement-preventing cover is mounted to the connector body via a hinge such that the cover can be opened and closed. The disengagement-preventing cover closes a top portion of the connector body to prevent the crimp contact from coming off upward after mounted in the connector body.

In the electrical connector of the present invention, the crimp contact is inserted and fitted into the fitting portion of the connector housing in a direction perpendicular to the direction in which the crimp contact is pulled out by the connector cable. Consequently, there is no possibility that the crimp contact is pulled out in the longitudinal direction of the connector cable. The crimp contact mounted in the connector housing is prevented from rattling in position in the longitudinal direction. Consequently, the contact of the contacting portions of the crimp contact is stabilized.

### BRIEF DESCRIPTION OF THE DRAWINGS

FIG. 1 is a vertical cross section of an electrical connector according to an embodiment of the present invention;

FIG. 2 is a cross-sectional view taken on line 2-2 of FIG. 1;

FIG. 3 is a vertical cross section of an electrical connector according to a prior-art example, showing the manner in which a crimp contact is fitted in a connector housing having a molded lance;

FIG. 4 is a vertical cross section of an electrical connector according to another prior-art example, showing the manner in which a crimp contact having a contact lance is fitted in a connector housing;

FIGS. 5A and 5B are a front elevation and a vertical cross section in side elevation, respectively of an electrical connector according to a further prior-art example; and

FIGS. 6A and 6B are a front elevation and a vertical cross section in side elevation, respectively, of an electrical connector according to a further prior-art example.

### DETAILED DESCRIPTION OF THE PREFERRED EMBODIMENTS

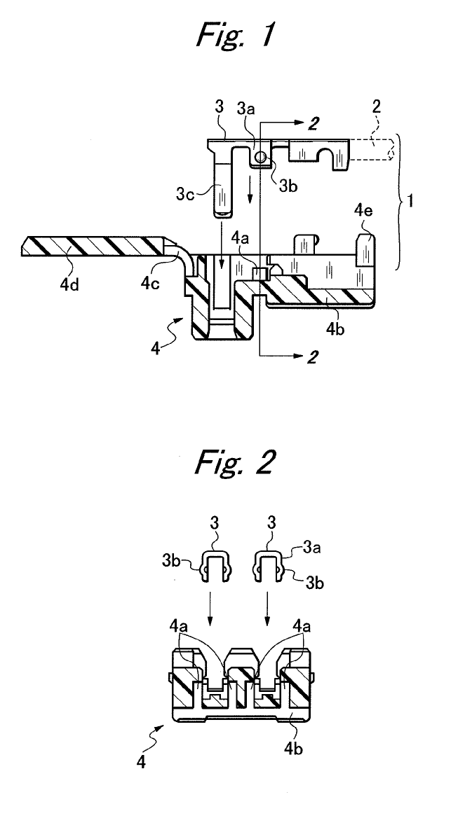

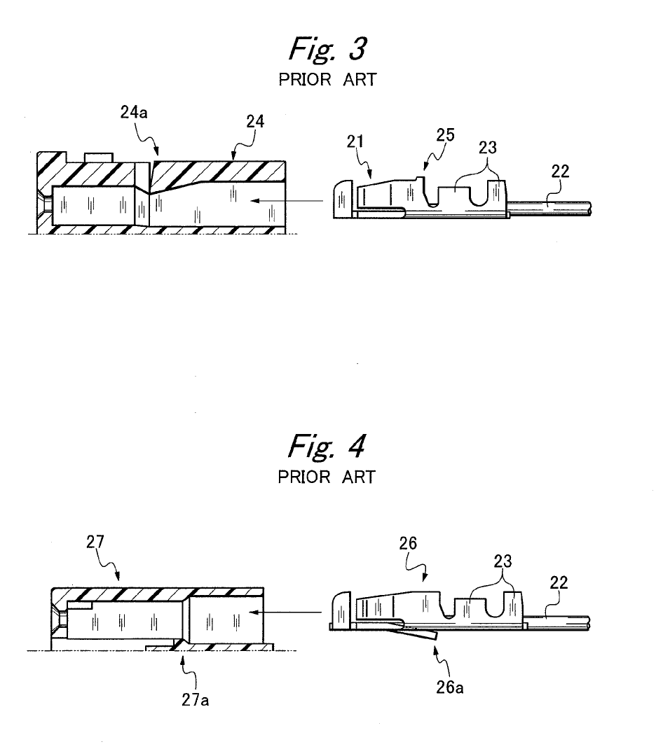

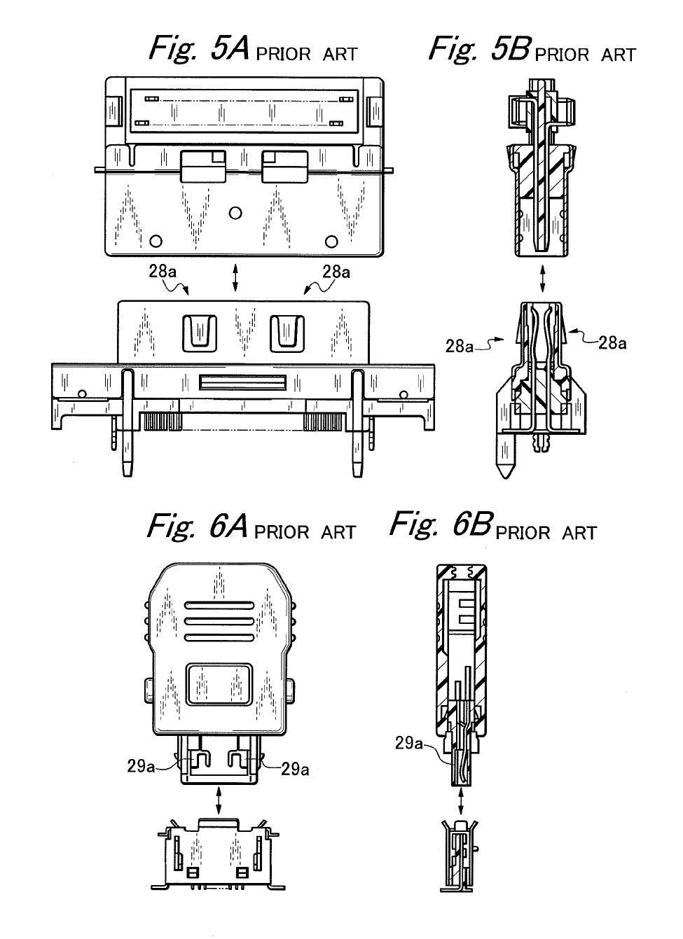

Referring to FIGS. 1 and 2, an electrical connector 1 according to the present invention includes a crimp contact 3 and a connector housing 4 made of a synthetic resin. The crimp contact 3 is electrically connected with a connector cable 2. The housing 4 places the crimp contact 3 in position and holds the contact 3.

As shown in FIG. 2, in the electrical connector 1, semispherical engagement protrusions 3b project outward from sidewall surfaces 3a of U-shaped cross section of the crimp contact 3. The connector housing 4 includes a connector body 4b and a disengagement-preventing cover 4d being a cover member that can be opened and closed via a hinge 4c. The connector body 4b has groove-shaped accommodation portions in which the crimp contact 3 with which the connector cable 2 is connected is received. Concave engagement portions 4a in which the protrusions 3b are engaged are formed in both sidewalls of each accommodation portion.

The distance between the both sidewall surfaces of the crimp contact 3 (i.e., the dimension of the outer width) is set to be slightly smaller than the dimension of the inner width of the accommodation portions in the connector body 4b. The distance between the protrusions 3b (the dimension of the outer width) is set to be larger than the dimension of the inner width of the accommodation portions. When the crimp contact 3 connected with the connector cable 2 is inserted into the accommodation portions inside the connector body 4b from above, the protrusions 3b of the crimp contact 3 come into engagement with the upper fringes of the engagement portions 4a and 4b, respectively. As a result, the protrusions 3b are anchored.

After the crimp contact 3 is accommodated and anchored in the connector body 4b as described previously, the disengagement-preventing cover 4d is rotated about the hinge 4c to close the opening in the top portion of the connector body 4b. The closed cover 4d is engaged and anchored to a locking portion 4e standing upright from the rear end of the connector body 4b and becomes locked. The crimp contact 3 is engaged and anchored by the engagement portions 4a. In addition, upward escaping motion is doubly prevented by closing the disengagement-preventing cover 4d in this way.

When the crimp contact 3 has been mounted, the protrusions 3b engage the engagement portions 4a. The disengagement-preventing cover 4d suppresses upward motion to thereby prevent the connected cable 2 from coming off if it is pulled in the longitudinal direction. The protrusions 3b are reliably engaged and anchored by the resilient force of the sidewall surfaces 3a that tend to spread apart outwardly.

In this way, in the electrical connector 1, the crimp contact 3 with which the connector cable 2 is connected is placed in position and held both in the direction in which the cable 2 is pulled and in the perpendicular direction. Therefore, when the connector has been mounted, it rattles neither in the longitudinal direction nor in the perpendicular direction. The contact position of the contact portion 3c of the crimp contact 3 is stabilized.

What is claimed is:

1. An electrical connector having a crimp contact electrically connected with a connector cable and a connector housing for placing the crimp contact in position and holding the crimp contact;
wherein said crimp contact has sidewall surfaces of U-shaped cross section, the sidewall surfaces being located on opposite sides, the sidewall surfaces having outwardly facing engagement protrusions;
wherein said connector housing has a connector body and a disengagement-preventing cover for closing a top portion of the connector body to prevent the crimp contact from coming off upward after the crimp contact has been mounted in the connector body the cover being mounted to the connector body via a hinge so as to be capable of being opened and closed; and
wherein the connector body has engagement portions into which the engagement protrusions of the crimp contact are inserted and received in a direction perpendicular to a longitudinal direction of the connector cable, the protrusions being engaged in the engagement portions.
